(19) United States
(12) Patent Application Publication
(10) Pub. No.: US 2007/0007189 A1
(43) Pub. Date: Jan. 11, 2007

(54) Oil reconditioning device and associated methods

(76) Inventor: Matthew Luntz, Highland, UT (US)

Correspondence Address: THORPE NORTH & WESTERN, LLP., 8180 SOUTH 700 EAST, SUITE 200, SANDY, UT, 84070, US

(21) Appl. No.: 11/178,088

(22) Filed: Jul. 8, 2005

(51) Int. Cl. C02F 1/02

(52) U.S. Cl. 210/180

(57) ABSTRACT

A device and method for reconditioning oil or vaporizing volatile fluids from oil of internal combustion engines in order to extend the oil service life is disclosed and described. Such a device can include a housing which defines an enclosed open chamber that can receive heated engine oil. A spray nozzle, a vapor outlet, and a reconditioned oil outlet may be coupled to the housing. In addition, the disclosed oil reconditioning device may also include a supplemental heating source such as an electrical heating element placed upstream of the device or integrated as part of the device. The oil reconditioning devices can spray engine oil into the open chamber to increase the surface area of the engine oil. The increase in surface area and design of the reconditioning device can increase the vaporization rate of volatile fluids to form a reconditioned oil. The reconditioned oil has a significant reduction in water and fuel content thus allowing for reduced service intervals and increased useful oil life.

### FIELD OF THE INVENTION

The present invention relates generally to oil reconditioning devices used in internal combustion engines and in particular to devices and methods for the continuous removal of volatile fluids and contaminants, such as water and fuel, found in engine lubricating oil. Accordingly, the present application involves the fields of chemistry, materials science, and thermodynamics.

### BACKGROUND OF THE INVENTION

Internal fuel combustion engines are used in a variety of circumstances such as automobiles, marine crafts, aircrafts, locomotives, diesel trucks, stationary diesel engines, to name a few. All internal combustion engines have moving parts which are susceptible to wear and damage during operation due to the presence of foreign material and/or breakdown of engine oil. Engine oils are used to lubricate interfaces or surfaces between the moving parts; however, volatile fluids and contaminants found in engine oils can significantly reduce the useful service life of the oil. Many have realized that engine oils having an extended service life can provide wide spread benefits, therefore attempts have been made to accomplish this purpose.

Generally, a number of methods and approaches have been implemented by those in the industry to extend the engine oil service life. One specific approach has been to formulate oils to include various additives. For example, additives can be designed to reduce or prevent oxidation, prevent oil breakdown, and/or reduce agglomeration of particulates. In addition, specific additives such as viscosity modifiers have also been used to extend the temperature range over which the oils operate thereby improving the service life of the oil. However, such additives typically have a finite period of usefulness until the additive is exhausted or otherwise rendered ineffective.

Another common approach for extending oil service life is to filter the oil in an attempt to remove particulate matter. Typically, full flow particulate filters are utilized to filter particulates to extend service life. These particulate filters have become a standard in internal combustion engines, however, merely removing particulates from engine oil only accounts for a portion of the contaminants. The presence of water and other volatile fluids in lubricating engine oils can also reduce the service life of the oil and can be detrimental to internal engine performance. Moisture or volatile fluids can result in the production of unwanted corrosion and oxidation producing acids and additional particulates.

Previous attempts to develop processes which reduce water content or other volatile fluids from engine oil have been met with varying degrees of success. Some of these processes have utilized surfaces with varying shapes to form a thin film of oil which may increase the vaporization rate of volatile fluids. Additionally, heat may be applied to these surfaces to increase the temperature of the oil thereby further facilitating the vaporization of the volatile fluids.

Although these previous attempts have improved oil quality and extended service life to some degree, there are limits as to their commercial practicability. Therefore, while arguably effective, each of these attempts suffers from problems such as unreliable performance, increased chamber retention times, limited practicality, inefficiency, increased costs, and other deficiencies which prevent their widespread use.

As such, systems and methods offering removal of volatile fluids thereby providing improved oil quality and extended service intervals, and which are suitable for use in practical applications continue to be sought through ongoing research and development efforts.

### SUMMARY OF THE INVENTION

Accordingly, the present invention provides devices and methods for removing contaminants such as water and volatile fluids from engine lubricating oils to extend the oil service life. An oil reconditioning device as provided by the present invention may include a housing which defines an enclosed open chamber capable of receiving heated engine oil. A spray nozzle may be coupled to the housing such that the nozzle is in direct fluid communication with the open chamber. The spray nozzle can spray the heated engine oil directly into the open chamber such that volatile fluids are vaporized from the heated engine oil to form a reconditioned oil. In addition, a vapor outlet may be coupled to the open chamber to allow removal of volatile fluids which are vaporized from the heated engine oil. A reconditioned oil outlet can be coupled to the open chamber for the recovery of the reconditioned oil. Furthermore, an optional heating element may be thermally coupled to the housing to supply heat to the heated engine oil.

In one alternative aspect, a method of reconditioning oil is provided. Such a method may include spraying a pressurized heated engine oil along a substantially unimpeded trajectory directly into an enclosed open chamber through a spray nozzle. The open chamber may be at a lower pressure than the pressurized heated engine oil to facilitate vaporization of volatile fluids found in the heated engine oil. Typically, the pressure in the open chamber has a pressure that is about ambient, and the pressure at the spray nozzle can generally be from about 25 psig to about 100 psig, although other operating pressures can be functional. As a result, a significant portion, e.g., typically up to about 90%, of the volatile fluids are flash vaporized. Once vaporized from the heated oil, the volatile fluids may be vented from the open chamber through a vapor outlet. The resultant oil is a reconditioned oil which has reduced water content and volatile fluids thereby allowing for extended service life. The reconditioned oil can then be removed through an oil outlet such as by gravitational flow.

In yet another aspect, a reconditioning device may include a housing defining an enclosed open chamber; an atomizing spray nozzle; a heating element; a vapor outlet; and a reconditioned oil outlet. The atomizing spray nozzle may be coupled to the housing in direct fluid communication with the open chamber and configured to spray heated engine oil into the open chamber such that volatile fluids are vaporized from the heated engine oil to form a reconditioned oil. Further, the heating element can be operatively connected upstream of the spray nozzle configured to supply heat to the heated engine oil. The vapor outlet and reconditioned oil outlet may be coupled to the open chamber for removal of volatile fluids and reconditioned oil, respectively.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic drawing of an oil reconditioning device in accordance with one embodiment of the present invention.

FIG. 2 is a schematic drawing of an oil reconditioning device in accordance with an alternative embodiment of the present invention.

FIGS. 3a, b, c and d are cross-sectional illustrations of impingement spray patterns in accordance with several embodiments of the present invention.

FIGS. 4a and 4b are schematic drawings of an oil reconditioning device and a powered return mechanism in accordance with an embodiment of the present invention.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “an outlet” includes one or more of such features, reference to “an interior surface” includes reference to one or more of such surfaces, and reference to “a coupling step” includes reference to one or more of such steps.

### Definitions

In describing and claiming the present invention, the following terminology will be used in accordance with the definitions set forth below.

As used herein, “reconditioned oil” means an oil that has been restored, improved or purified by at least removing volatile fluids therefrom so as to improve oil performance. The engine oil can be any oil that can be used in an internal combustion engine for lubricating purposes.

As used herein, “volatile fluid” refers to any fluid that can be readily vaporized. Particularly, as used herein, volatile fluid refers to any fluid that has a lower boiling point than engine oil and can functionally be evaporated from the engine oils. Non-limiting examples of common volatile fluids include water and combustible fuels such as gasoline and diesel fuel.

As used herein, “atomizing” refers to reducing engine oil flow to fine particles, droplets, or a fine spray. Thus, atomizing of the engine oil can significantly increase exposed surface area such that migration of volatile fluids within the engine oil toward oil droplet surfaces occurs and volatilization thereof are enhanced.

As used herein, “bypass” refers to a process that is configured to treat only a portion of the circulating engine oil. For example, the present invention may be capable of treating about 2 to 15 vol % of the total circulating engine oil, although the specific capacity can be designed to accommodate a wide variety of applications.

As used herein, “full flow” refers to processing or filtering substantially all of the total circulating engine oil.

As used herein, “enclosed” refers an area that is substantially or completely surrounded by a housing, which defines an internal space or area, which can be substantially open. Thus, an enclosed area is isolated from ambient conditions by various materials such as housing walls, valves, and the like.

As used herein, “open chamber” refers to a space that is substantially or completely enclosed by a rigid material. In accordance with the present invention, the open chamber may be defined by walls and may have inlets and outlets to form an open chamber.

As used herein, “supplemental heating source” refers to any heating source which is used to heat the oil other than the intrinsic heating resulting from passage through the cavities of an operating engine. Examples of supplemental heating sources can include electrical resistive heating elements and the like.

As used herein, “thermally coupled” refers to a relationship of identified elements such that thermal energy can be transferred from one element to another element. Thermally coupled elements typically involved direct physical contact, although any configuration which allows conduction, convection, and/or radiation transfer of useful quantities of heat can be used.

As used herein, “metallic” refers to a metal, or an alloy of two or more metals. A wide variety of metallic materials are known to those skilled in the art, such as aluminum, copper, chromium, iron, steel, stainless steel, titanium, tungsten, etc., including alloys and compounds thereof.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

It should be noted that when referring to items in the figures, certain numerals from one figure to the next denote similar structures. Thus, it is not necessary to re-identify each and every numeral in each figure where a new feature is to be described.

### The Invention

The present invention is drawn towards devices and methods that offer an effective and economical option for removing volatile liquid contaminants from lubricating engine oils. Specifically, the present invention can be used to recondition engine oil and remove volatile contaminant fluids that may cause damage to internal combustion engines.

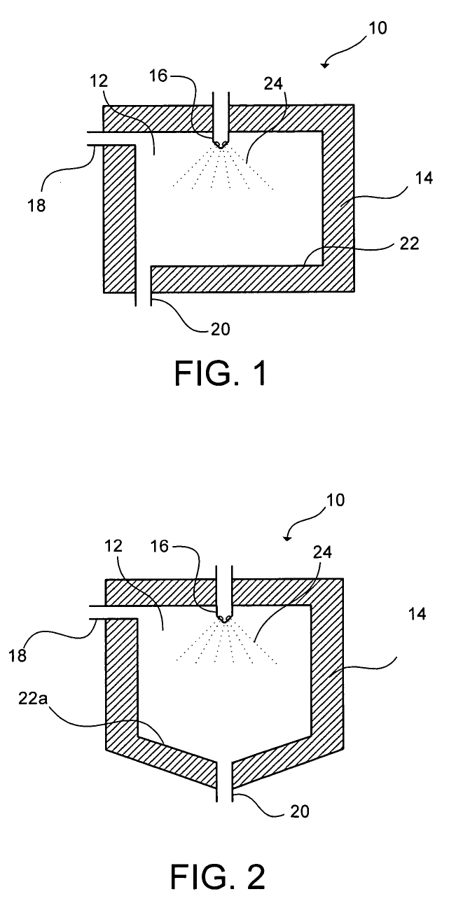

Referring now to FIG. 1, an oil reconditioning device is shown generally at 10 in accordance with one embodiment of the present invention. A housing 14 can be shaped in a desired configuration to define an enclosed open chamber 12. The housing can have a spray nozzle 16, a vapor outlet 18, and a reconditioning oil outlet 20 coupled thereto as shown and described in more detail below.

The housing 14 may be formed into any shape that defines an enclosed open chamber 12 and is capable of retaining fluids. Generally, the housing can be formed in a variety of shapes, non-limiting examples are, a cylinder, cone, or rectangular chamber. In one aspect, the housing can be formed in a rectangular shape having a substantially flat bottom surface 22 as shown in FIG. 1. In an alternative embodiment, a bottom portion of the housing can be formed in a conical shape as shown in FIG. 2, having a bottom surface 22a sloping downward to an oil outlet 20. This sloped configuration can facilitate the removal of reconditioned oil by allowing gravity to direct the reconditioned oil down to and out through the oil outlet.

A variety of rigid materials may be used for the fabrication of housing 14. Preferably, the housing can be fabricated from materials that are capable of retaining fluids and withstanding temperatures up to about 150° C., and preferably up to about 225° C. without deforming. Most of the materials described below operate well above these temperatures; however, the reconditioning device is typically not operated over about 150° C. In addition, the open chamber 12 can be at a lower pressure than the pressurized heated engine oil. Typically, the open chamber operates at about ambient pressure. However, the housing should also be fabricated from materials that can withstand pressures up to about 100 psig. Specific examples of materials that can be used include, without limitation, stainless steel, cast iron, aluminum, plastic, ceramic, and alloys or composites thereof. In some embodiments the housing can comprise or consist of a metallic material. In one embodiment, the metallic material may be aluminum, or an aluminum alloy. In another embodiment, the metallic material may be stainless steel, or a stainless steel alloy. Important considerations when choosing materials include providing materials that have a sufficient rigidity and toughness. Aluminum for example, is easily formable, rigid, light weight, and also cost effective. In another embodiment, the housing can be formed of a ceramic material. Many ceramic materials can exhibit desirable thermal properties such as relatively low thermal emissivity and good thermal isolation.

The housing 14 can be formed using any number of techniques such as metal casting, die casting, or machining processes, to name a few. In one embodiment, an aluminum housing may be formed by a die casting process. One forming process may be desirable over another depending on the materials being formed into the housing. The forming process can account for design configurations that allow for an open chamber that provides for a substantially unimpeded oil spray trajectory. In other words, the housing can be formed such that the open chamber 12 does not have any protrusions that might obstruct the sprayed oil trajectory. In this way, the oil may achieve the desired particle size and surface area configuration.

Additionally, the housing 14 may be insulated with an insulation jacket which decreases heat loss to the surroundings. Alternatively, or in addition to the insulation jacket, the interior or exterior surfaces may be coated with a material which is designed to improve heat transfer to the oil. In one embodiment, the interior surface may be coated with a high performance coating. High performance coatings can include, but are not limited to, ceramics, polymers such as polysiloxanes, epoxies, and the like. Retaining heat of the entering engine oil can further improve the vaporization efficiency by maintaining a higher temperature, thereby facilitating evaporation of volatile fluids as described below.

Although the heat of the entering engine oil may not be able to be completely retained, a heating source, such as an electrical heating element may be operatively coupled to the housing 14 in some embodiments. Typically, the heating source is thermally coupled upstream of the spray nozzle 16 in order to supply heat to the already heated engine oil. Alternatively, the heating source may be physically or thermally coupled at any location either on the top, bottom, or sides of the housing, thereby providing a heating source which is capable of maintaining or increasing the temperature of the engine oil as it enters the open chamber 12. Notably, the increase in temperature can decrease the vaporization time needed for removing volatile fluids entrained in the engine oil. There are a number of supplemental heating sources that may be employed by the present invention. Generally, any heating source that is capable of supplying heat to the engine oil can be utilized. Currently, an electrical heating element can be a preferred heating source as such can be operatively connected to the vehicle electrical system. In this manner, additional heat can be supplied to the engine oil sufficient to increase vaporization of undesirable volatile fluids.

Another method that can aid in the vaporization process is to increase the surface area of the engine oil by spraying the oil 24 into the open chamber 12 through a spray nozzle 16. Since volatile fluids are typically at least partially well mixed into the oil, i.e. as a partial solution, emulsion or dispersion, increasing the surface area of the oil can increase the evaporation rate of the volatile fluids. Specifically, the increased surface area facilitates the migration of the volatile fluids to the surface of the oil where they can readily evaporate into the open chamber. Therefore, a greater oil surface area or greater number of droplets formed per volume of oil will generally correspond to a greater rate of vaporization of the volatile fluids. For this reason, spraying engine oil into the open chamber through a spray nozzle can be advantageous for increasing the engine oil surface area.

In one embodiment, at least one spray nozzle 16 can be coupled to the housing 14. The spray nozzle can be in fluid communication with the open chamber 12 thereby providing a passage for spraying engine oil into the open chamber. The spray nozzle may be coupled at any functional location of the housing. For example, the spray nozzle can be located either on the top, bottom, or sides of the housing, depending on the particular configuration. In one embodiment the nozzle can be coupled to the side of the housing at any point above reconditioned oil which collects at the bottom of the open chamber. When coupled to the side of the housing the spray nozzle may be adjusted such that the nozzle may spray engine oil radially and upward along a diagonal trajectory. This type of configuration may increase the vaporization efficiency of volatiles entrained in the oil by extending the oil retention time in the open chamber, thereby allowing for more of the volatiles to be removed from the oil. Adjusting the flow rate of the engine oil as it is sprayed into the open chamber can also increase or decrease the oil retention time in the chamber. Increasing the retention time by reducing flow rates can allow the oil additional time to more completely vaporize and separate the volatile fluids from the oil.

Another way to achieve an optimal spray configuration can be to utilize and couple a plurality of spray nozzles to the housing. A plurality of spray nozzles may be needed to obtain the desired droplet size and flow rate of oil entering the chamber. For example, in one embodiment, two air atomizing spray nozzles may be attached and positioned at the top of the housing and configured to mist the engine oil into the open chamber, thereby increasing the total flow rate of oil entering the open chamber, while obtaining an optimized droplet size. Alternatively, spray nozzles can be positioned along a plurality of housing walls. For example, one or more spray nozzles can be located along each of the side walls and/or top of the housing.

Typically, the engine oil is sprayed into the open chamber 12 along a substantially unimpeded trajectory through a spray nozzle 16 at a flow rate from about 5 gph to about 25 gph. Furthermore, the temperature and pressure of the engine oil at the spray nozzle may be from about 50° C. to about 150° C., and from about 25 psig to about 100 psig, respectively. However, temperatures and pressures outside these ranges can also be useful, e.g., startup temperatures may be substantially below the above temperature range. Most often, typical engine operating temperatures range from about 90° C. to about 110° C. However, it should be kept in mind that the reconditioning devices of the present invention can be configured to have temperatures, pressures, and flow rates that are more adequate for larger or smaller applications, e.g., moped engines, automotive engines, industrial oversized dump trucks, large marine vessels, etc.

There are a number of suitable spray nozzles 16 that can be coupled to the housing 14 which may alter the flow rate and increase the surface area of the entering engine oil. Specific examples of spray nozzles that can be used can include, without limitation, an atomizing nozzle, a free flowing nozzle, a hollow cone nozzle, a flat fan nozzle, spiral full cone nozzle, to name a few. In one embodiment the spray nozzle coupled to housing can be an atomizing nozzle. Typically, any spray nozzle that increases the surface area of the engine oil entering the open chamber can be employed by the present invention. Generally, spray nozzles increase the surface of the engine oil by forming oil droplets. Notably, droplet size, spray pattern and vaporization rate can be altered depending on the spray nozzle used.

As previously mentioned, spray nozzle 16 may be configured to spray the engine oil in a predetermined spray pattern. Various patterns may be adapted by spray nozzles to further increase engine oil surface area. Since a variety of open chamber configurations and shapes may be used in accordance with the present invention, spray width, concentration and pattern should be considered when determining the optimal spray pattern for each configuration. Accordingly, the present invention may employ a number of spray patterns which may include without limitation, a hollow cone spray, a full cone spray, a flat spray, a fine spray, and an air atomizing spray patterns. In one currently preferred embodiment, the spray pattern can be a hollow cone spray.

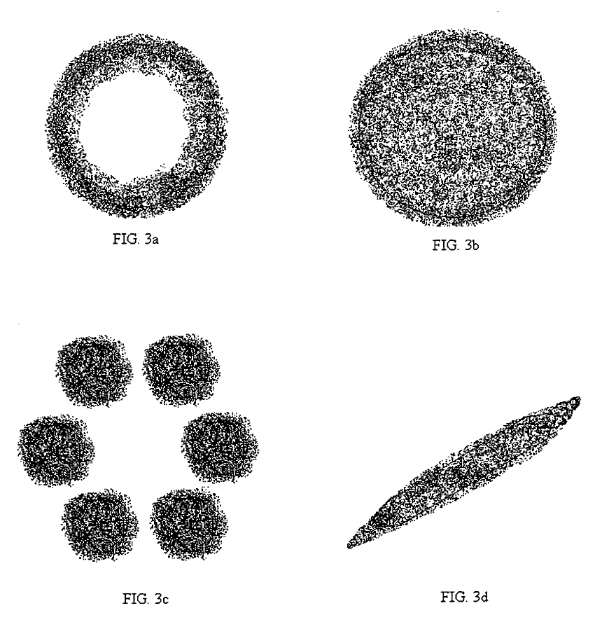

Referring to FIG. 3a, a cross-sectional illustration of an impingement spray pattern, depicts a hollow cone spray pattern according to one embodiment of the present invention. This hollow cone spray pattern provides concentrated oil particle spray around a perimeter, while leaving the center of the spray substantially empty. As a result, the concentration gradient of volatiles between exposed droplets and adjacent areas can be maximized to maintain an increased driving force for vaporization. FIG. 3b, illustrates an impingement spray pattern of a full cone spray. In this configuration, the device is able to fill a larger area with a more complete droplet spray and increased surface area. FIG. 3c, illustrates an impingement spray pattern of a clustered spray. The cluster in this embodiment accounts for six distinct spray trajectories. The clustered spray pattern may be achieved through a plurality of apertures in a nozzle, which may possibly allow for a higher flow rate that other spray nozzles. In a manner similar to FIG. 3a, the multiple spray patterns can allow for a relatively larger concentration gradient of volatile fluids between oil droplets and adjacent areas. FIG. 3d, illustrates an impingement spray pattern of a full fan spray. Although only a few spray patterns have been illustrated many other spray nozzles and patterns may be used in conjunction with the present invention. Choosing the proper spray nozzle, one skilled in the art can vary oil flow rates, spray pattern profiles, and open chamber configuration, to provide optimal volatile vaporization. In addition, the spray pattern utilized may be adjusted such that the surface area of heated engine oil entering the open chamber may be maximized. Depending on the position and configuration of the oil outlet as described below, the spray pattern can be adjusted for additional retention time within the chamber prior to removal of the reconditioned oil. As the volatile fluids become vaporized in the open chamber 12, a vapor outlet 18 can be coupled to the housing 14 and configured for removal of volatile fluids from the open chamber. Typically, the vapor outlet will be positioned above any outlets 20 that may be coupled to the open chamber. The vapor outlet may be positioned and shaped into any configuration that allows for the volatilized gases to vent from the open chamber. The vapor outlet can be provided in the form of an open outlet, a pressure relief valve, or any other functional member which allows for removal of volatilized fluids without compromising separation performance. In one embodiment, a plurality of vapor outlets may be coupled to the housing and which are in fluid communication with the open chamber. As previously noted, once the volatile fluids are vaporized from the engine oil, the resultant oil can be collected and removed from the open chamber as a reconditioned oil.

Removal of the reconditioned oil may be accomplished by a reconditioned oil outlet 20 coupled to the housing 14 which is in fluid communication with the open chamber 12. The oil outlet provides a passage for the desired oil to exit and return to the oil sump, engine block, or other unit of the engine system. The reconditioned oil outlet is typically oriented below each of the spray nozzle 16 and vapor outlet, although this is not always required. Notably, the reconditioned oil outlet may be coupled to a side wall of the housing. Alternatively, the reconditioned oil outlet may be coupled to a bottom surface of the housing, thereby allowing gravity to remove the reconditioned engine oil as shown in FIG. 2. By orienting the oil outlet below each of the spray nozzle 16 and vapor outlet 18, gravity can be used as the primary force to remove the reconditioned oil from the unit 10. Further, problems associated with clogging or blockage of the spray nozzle or vapor outlet can be avoided by placing the outlet below each of the spray nozzle and vapor outlet.

Additional features may be included with the present invention to improve the removal of the reconditioned oil from the device. For example, a powered return mechanism can be coupled to the device. Accordingly, the powered return device may be operatively connected to the oil reconditioning device such that reconditioned oil is forced out through the reconditioned oil outlet. Non-limiting examples of powered return mechanisms which can be used include a negative pressure device, a pneumatic float valve, a co-impeller, and an electrical pump. Various means for forcing the reconditioned oil from the reconditioning device can be considered. The above listed powered return mechanisms include the currently preferred means for forcing oil from the reconditioning device.

Further, it has been discovered that using a standard ½″ line under gravity flow in connection with the present invention can in some embodiments allow air bubbles to be trapped in the line causing blockage. Accordingly, a larger ¾″ line can be used to alleviate this difficulty. Unfortunately, not all engines are equipped with ports of this size. However, a powered return mechanism such as those described herein can be used to allow use of the standard size line without sacrificing performance.

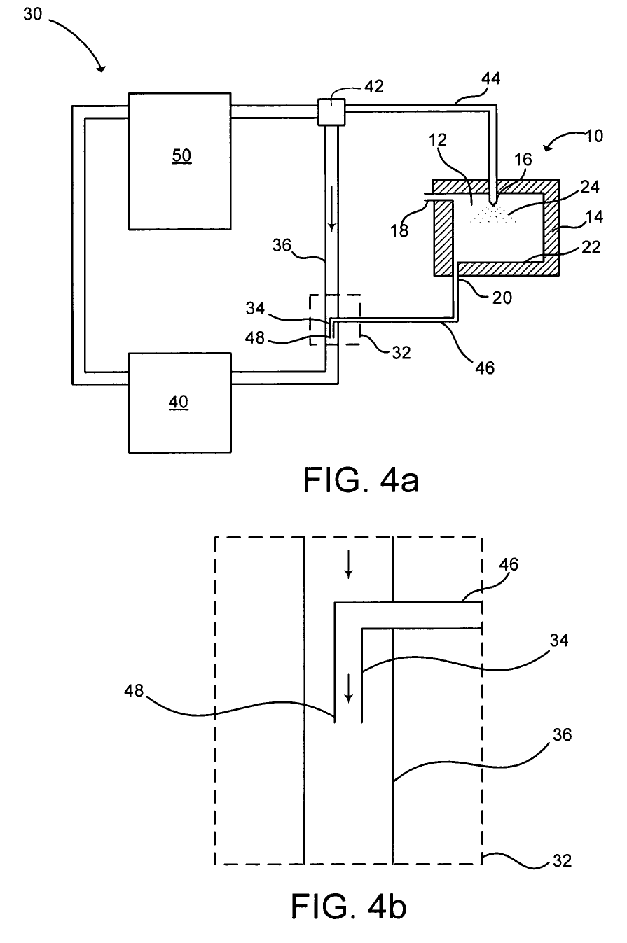

Incorporating a negative pressure device with the present invention can increase the flow of the reconditioned oil and avoid any clogging or blockage associated with the oil returning to the engine. Typically, the negative pressure device can include a reconditioned oil line fluidly coupled to the reconditioned oil outlet and an oil return line. In this embodiment the reconditioning device may be configured as an oil bypass device, treating only a portion of the total circulating oil and redirect the reconditioned oil to an oil return line, as described below. Referring now to FIGS. 4a and 4b, an engine oil purifying system 30 can include a full flow particulate filter 50 and an oil reconditioning device 10 fluidly coupled. Typically, lubricating oil circulates from an engine 40 to a full flow particulate filter 50. The particulate filter can remove relatively large particulates from the circulating engine oil, as described below. Upon exiting the full flow particulate filter, the engine oil can pass through an oil separator 42, e.g. an open T junction or the like. Generally, the separator is capable of directing a portion of the circulating oil to an oil return line 36 and an oil inlet line 44 fluidly coupled to the spray nozzle 16 of the oil reconditioning device.

As shown in FIG. 4a, the oil flow rate through each of oil return line 36 and oil inlet line 44 can be controlled and or designed to obtain a desired flow rate through the reconditioning device. For example, the reconditioning device may continuously treat from about 2 vol % to about 40 vol % of the total engine oil, and preferably about 10 vol % to about 20 vol %. The relative oil flow rates can be adjusted by appropriate choice of the diameter of an inlet line connected to the reconditioning device. In one embodiment, the oil inlet line can be fluidly coupled to the spray nozzle 16 and can have a diameter that corresponds to desired fluid flow. In another embodiment, the oil inlet line can originate from an engine oil return line and can have a diameter less than the engine oil return line. A smaller diameter can result in a lower oil volume percent being treated and a lower fluid flow rate as compared to the fluid flow rate in the engine oil return line.

The volatile fluids can be removed through a flash vaporization process once the oil enters the open chamber 12, resulting in a reconditioned oil as described herein. The reconditioned oil can then be removed through the use of a pressure differential driven mechanism from the open chamber through the reconditioned oil outlet 20 positioned below the spray nozzle 16 and the vapor outlet 18. A negative pressure device 32 can include a reconditioned oil return line 46 being fluidly coupled to the reconditioned oil outlet. The reconditioned oil return line can have an end portion 34 distal to the reconditioned oil outlet and which can be concentrically oriented within the oil return line. The end portion can be oriented having an opening 48 thereof directed downstream with the fluid flow from the oil return line. As oil flows past the opening 48, the flowing fluid creates a negative pressure within the reconditioned oil return line 46, thereby increasing the flow and removal of the reconditioned oil from the open chamber. This powered return embodiment is currently preferred over others because of an absence of moving parts or complex designs.

FIG. 4b, illustrates an enlarged view of the negative pressure device 32 having a reconditioned oil return line 46 fluidly coupled to the reconditioned oil outlet and an oil return line 36. Particularly, FIG. 4b illustrates the reconditioned oil return line having an end portion 34 distal to the reconditioned oil outlet and being concentrically oriented within the oil return line and oriented having an opening 48 thereof directed downstream.

As previously mentioned, other powered return mechanisms may be utilized in conjunction with the present invention. For example, a co-impeller (not shown) may be coupled to the oil return line 36 and a reconditioned oil return line 46. The co-impeller can be mechanically configured to be a fluid driven assembly. One impeller may be disposed within the oil return line and mechanically coupled to the other impeller disposed in the reconditioned oil return line, e.g. along a common axle. The impeller in the oil return line is driven by the oil as it flows through the line. Because the both impellers are mechanically coupled, the movement of the impeller in the oil return line drives the impeller in the reconditioned oil return line, thereby causing the reconditioned oil flow rate to increase.

Another embodiment of the powered return mechanism can include a pneumatic float valve coupled to the oil reconditioning device. A float valve is positioned in the chamber to contact the reconditioned oil at a predetermined level. Upon contact with the rising reconditioned oil, the float opens a pressurized air valve in the open chamber thereby releasing pressurized air into the chamber. The pressurized air increases the internal pressure of the open chamber and flushes the reconditioned oil out of the chamber and through the reconditioned oil outlet. This embodiment is particularly suited for use in vehicles that utilize a pneumatic system such as, diesel trucks.

In yet another embodiment, the powered return mechanism can be an electric pump fluidly coupled to the reconditioned outlet such that the reconditioned oil may be pumped out of the reconditioned device and back to the oil pan or sump at a predetermined flow rate. An electrical pump can be readily installed in most vehicles directly into the existing vehicle electrical system.

Removal of volatile fluids from the engine oil can be considered at least as important as removing solid particulates from the engine oil such as metal shavings, particulate materials, etc. Full flow particulate filters may be used in conjunction with the present invention to filter out these particulates. The full flow filters are typically designed to allow for sufficient oil flow such that the engine is not starved of oil. Generally, the full flow filters are considered primary filters that remove particulates in the range of about 1 micron to about 50 microns from engine oil. The size of the particles filtered is determined largely based upon the filter mesh size. However, as discussed above, these types of full flow filters lack the ability to remove other contaminants such as water, and other volatile fluids. Therefore, it can be advantageous to utilize a full flow particulate filter in conjunction with, or parallel with, a reconditioning device as disclosed herein.

In one embodiment, an oil reconditioning device can be mounted in fluid communication with a full flow particle filter as a single integrated unit. In another embodiment, an oil reconditioning device may be mounted in fluid communication as a separate unit in series with a full flow particle filter. The full flow filter can thus remove particulates from the entering oil stream prior to spraying the oil into the open chamber. Therefore, the full flow filter can be operatively connected to or positioned upstream from the spray nozzle.

The reconditioning device 10 as recited herein can be used in a secondary or a bypass configuration such that only a portion of the total engine oil is circulated through the reconditioning device. Alternatively, the reconditioning device can be configured as a full flow reconditioning device. The reconditioning devices of the present invention are generally very effective at removing volatile fluids from the engine oil. At standard operating conditions, the reconditioning devices of the present invention can remove from about 85 vol % to about 96 vol % of volatile fluids from the engine oil, and typically about 90 vol %. Since the devices of the present invention are highly effective at removal of volatile fluids, the device is generally used as a bypass instead of a full flow. A bypass configuration generally works in conjunction or parallel with full flow filters. A typical bypass configuration can continuously treat a portion of the total circulating engine oil. In accordance with one aspect of the present invention, the reconditioning device may continuously treat from about 2 to about 15 vol % of the total engine oil, although other flow rates can be designed depending on the particular engine and intended operating conditions. Reconditioning devices configured in a bypass configuration can purify the engine oil from fluid contaminants such as water and fuel that a conventional full flow particulate filter cannot, to produce a substantially continuously reconditioned engine oil having an extended service life.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An oil reconditioning device, comprising:
a) a housing defining an enclosed open chamber;
b) a spray nozzle coupled to the housing in direct fluid communication with the open chamber and configured to spray a heated engine oil into the open chamber such that volatile fluids are vaporized from said heated engine oil to form a reconditioned oil;
c) a vapor outlet coupled to the open chamber for removal of the volatile fluids; and
d) a reconditioned oil outlet coupled to the open chamber for removal of the reconditioned oil.

2. The device of claim 1, further comprising a heating element thermally coupled to the housing to supply heat to the heated engine oil.

3. The device of claim 1, further comprising a heating element operatively connected upstream of the spray nozzle to supply heat to the heated engine oil.

4. The device of claim 1, wherein the spray nozzle is an atomizing nozzle.

5. The device of claim 1, wherein the spray nozzle is configured to spray the heated engine oil along a substantially unimpeded trajectory into the open chamber.

6. The device of claim 1, wherein the spray nozzle is configured to spray engine oil in a predetermined pattern into the open chamber.

7. The device of claim 7, wherein the pattern is selected from the group consisting of hollow cone, full cone, flat, and air atomizing spray patterns.

8. The device of claim 1, wherein the housing comprises a material selected from the group consisting of stainless steel, cast iron, aluminum, plastic, ceramic, and alloys or composites thereof.

9. The device of claim 1, wherein the open chamber is at a lower pressure than a pressure at the spray nozzle.

10. The device of claim 1, further comprising a particulate filter operatively connected upstream of the spray nozzle.

11. The device of claim 1, wherein said device is configured for use as an engine oil bypass device capable of treating a portion of total engine oil.

12. The device of claim 11, wherein said portion is from about 2 to about 15 vol % of the total engine oil.

13. The device of claim 1, further comprising a powered return mechanism operatively connected to the device to force the reconditioned oil out the reconditioned oil outlet.

14. A method of reconditioning oil, comprising introducing heated engine oil into the device as recited in claim I and removing reconditioned oil from said device.

15. A method of reconditioning oil, comprising the steps of:
a) spraying a pressurized heated engine oil along a substantially unimpeded trajectory directly into an enclosed open chamber through a spray nozzle, wherein said open chamber is at a lower pressure than the pressurized heated engine oil, such that volatile fluids in the heated engine oil vaporize to form a reconditioned oil and vaporized volatile fluids;
b) venting the vaporized volatile fluids from the open chamber; and
c) removing the reconditioned oil.

16. The method of claim 15, wherein the step of spraying includes atomizing the pressurized heated engine oil.

17. The method of claim 15, wherein the pressurized heated engine oil has an inlet temperature and further comprising the step of increasing the inlet temperature of the pressurized heated engine oil prior to the step of spraying the pressurized heated engine oil.

18. The method of claim 15, wherein the pressurized heated engine oil has a temperature from about 90° C. to about 110° C. at the spray nozzle.

19. The method of claim 15, wherein the pressurized heated engine oil has a flow rate from about 5 gph to about 25 gph at the nozzle.

20. The method of claim 15, wherein the step of removing is accomplished using a powered return mechanism.

21. An oil reconditioning device, comprising:
a) a housing defining an enclosed open chamber;
b) an atomizing spray nozzle coupled to the housing in direct fluid communication with the open chamber and configured to spray heated engine oil into the open chamber such that volatile fluids are vaporized from said heated engine oil to form a reconditioned oil;
c) a heating element operatively connected upstream of the spray nozzle configured to supply heat to the heated engine oil;
d) a vapor outlet coupled to the open chamber for removal of the volatile fluids; and
e) a reconditioned oil outlet coupled to the open chamber for removal of the reconditioned oil.
